(19) United States
(12) Patent Application Publication
(10) Pub. No.: US 2009/0148817 A1
(43) Pub. Date: Jun. 11, 2009

(54) Management and Delivery of Embedded IDE Learning Content

(75) Inventors: Michael A. Lang, Issaquah, WA (US); Lee M. Ackerman, Calgary (CA); Craig C. Branham, Bellevue, WA (US); Alexander Kutsick, Bothell, WA (US); Michael Hartmann, Bothell, WA (US)

Correspondence Address: HAMILTON, BROOK, SMITH & REYNOLDS, 530 VIRGINIA ROAD, PO BOX 9133, CONCORD, MA, 01742-9133, US

(73) Assignee: International Business Machines Corporation, Armonk, NY (US)

(21) Appl. No.: 11/950,918

(22) Filed: Dec. 5, 2007

(51) Int. Cl. G09B 19/00

(52) U.S. Cl. 434/118

(57) ABSTRACT

A computer training system trains an end user on a computer-based tool having functional components. The training system associates each functional component with respective training materials and forms an educational component. The educational component is integrated into the work environment of the end user. Thus end user operation of the educational component and end user operation of the subject computer-based tool is in a same environment.

### BACKGROUND OF THE INVENTION

As software solutions have increased in complexity, users have grown to depend on Integrated Development Environments (IDEs) to handle increasingly difficult and complicated tasks. However, as the IDEs have become more sophisticated, they have actually become complicated in their own right, and now are as much a part of the problem as they are a part of the solution.

To address this complexity, IDEs can increase componentization, extensibility and configurability. IDEs, such as software based on Eclipse, NetBeans, or Visual Studio are increasingly customizable to suit different job roles, responsibilities, skill sets, and target platforms. Even though the user can customize the IDE—adding and removing functional components as needed, in many cases, this really exacerbates the problem.

The complexities of IDE's affect three distinct entities—the individual user, the user's organization and the vendors that support the IDEs. The following sections examine the problems from these three perspectives:

The problems facing individual users include:

Lower productivity, since they cannot figure out how to use the necessary features of the IDE effectively for the task at hand.

Frustration, since they are confused about what part of the tool to use and when.

Frustration, since the tooling cannot adjust to provide the level of support needed, based on the user's skill level.

Difficulty, finding and using training that is available when the level of training granularity does not correspond to the granularity of the functional components they need to use.

The user's organization faces a number of issues as well:

Purchased tools are not used to their full potential, and in a number of cases are not used at all, becoming shelf-ware.

Although resources are put into enabling the staff, the results are disappointing when the staff still is not proficient with the tooling.

It is difficult to keep track and manage the enablement effort.

It is difficult to track and manage user skill levels.

The level of skill retention is unacceptable.

The supporting software vendors face the following issues:

When current versions of the product end up as shelf-ware, it limits future sales.

Support costs are too high, limiting profitability.

Service teams spend time on low value aspects of engagements limiting customer success as well as the vendor's profitability.

It is difficult to get customers who download trial versions to convert to a purchase.

Currently people attempt to address these issues through traditional means: training, mentoring, adding more functionality to the tool, and providing help within the tool. These approaches fall short in addressing the issues listed above because:

The granularity of the training is coarser than is required by the user. This results in a mismatch between what is taught and what the student needs to know.

The tooling used for tracking enablement actually manages information at a coarser level.

Guidance as to when training should be taken is something that must be determined manually and is error prone.

It is difficult to get the right training, at the right time.

If the training is too coarsely grained, it often requires different training events to provide a set of components for the user. This can be inefficient for users who spend time learning about things that are not relevant and inefficient for an organization that has to pay for training that is not needed.

Adding more functionality to the tooling in the name of making it simpler, usually results in just the opposite.

Content provided in the help system is often too introductory and lacks details which would tie it to a real world usage.

### SUMMARY OF THE INVENTION

The present invention addresses the foregoing problems of how to achieve higher productivity using an Integrated Development Environment (IDE), a tool which is now essential for software developers creating software solutions.

In particular the present invention provides a new and unique approach for packaging, installing, managing and using training components within IDEs. There are three key elements that interact within this invention:
(1) The training is componentized, extensible and customizable, embedded in IDEs, such as Eclipse, NetBeans, Visual Studio, etc. Providing a solution to the productivity of IDEs needs to involve the IDE itself. A key ingredient is that the IDE becomes a collection of components, is extensible, and that users can easily configure it.
(2) Learning educational elements that have been packaged as components can be consumed, extended, and configured within the IDE.
(3) A management server hosts components and can communicate and interact with the IDE.

In a preferred embodiment, the present invention provides a method and apparatus for training an end-user to use a computer-based tool having one or more functional components. The invention system associates each functional component with respective training materials, and therefrom forms an educational component. The associating may be based on role of the end user. The educational component is integrated into the end-user's work environment (IDE). The end-user does not have to leave the IDE to complete the learning tasks. As a result, end user operation of the computer-based tool and the educational component are in the same environment.

Further the invention system may make recommendations of other training materials to the end user as a function of end user role(s), past training and functional component installation and/or usage by the end-user.

The functional components, training materials and formed educational components may be centrally managed. In one embodiment, the managing server further records end-user progress including noting educational components used by the end user and noting/tracking subject computer-based tool (functional component) performance at the hand of the end user.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a schematic illustration of a help screen view in an embodiment of the present invention.

FIG. 2 is a schematic illustration of another (i.e. subsequent) help screen view in the embodiment of FIG. 1.

FIGS. 3-5 are schematic illustrations of screen views generated by training components within the user's Integrated Development Environment (IDE) according to the present invention.

FIGS. 6 and 7 are schematic diagrams of a management server of the present invention.

FIG. 8 is a schematic view of a computer network environment in which embodiments of the present invention are implemented.

FIG. 9 is a block diagram of a computer node in the computer network of FIG. 8.

### DETAILED DESCRIPTION OF THE INVENTION

In the present invention, applicants look to leverage the componentization, extensibility and customization capabilities of the IDE to make the IDE more consumable, resulting in an increase in productivity. The solution calls for training associated with a functional component to be packaged as a set of components (referred to as learning components or educational components). In this way, the user can match up the granularity of the training to the capabilities of the functional component and the training is automatically tailored to the user's IDE configuration. The user sees only the training content for the IDE components installed.

In addition, this learning component operates within the environment of the IDE, leveraging the tools within the IDE to deliver the training. Applicants refer to this as Embedded Education because the educational material is embedded within the work environment. Now the user can employ the target tool as the host environment for training. In the past, a user would have required a separate tool (Web browser, specialized training tool, or perhaps even paper) to access and work with the training and training content. This Embedded Education allows the user to work and learn within their work environment.

Training content is in turn managed with a management server. This management server is able to host both functional and educational (learning) components. When a component is added to the management server, one is able to specify dependencies between that component and other components that the management server is already aware of. In this way, applicants can connect educational (learning) components to the functional components that they support. Based on this information, when a user references a functional component (either to install it, or because they have already installed it), the invention system presents to him a list of educational components that will teach him how to use the subject functional component.

The management server is able to make recommendations based on the training already accomplished, the functional components installed, and any past training the user may have already completed.

In addition, the management server can track and report the components that have been installed (both functional and educational) and report on who has taken what training. This can measure how students perform in their training, what training was taken, and to ensure for compliance purposes, that the necessary training was completed. Applicants refer to this as learning process choreography—the ability to work with the management server to ensure that it is clear what training relates to what functional components, to recommend which learning/educational components or parts thereof (generally referenced as training components) should be taken, and to track and manage the actual training that has been taken.

A description of example embodiments of the invention follows.

As mentioned above, the present invention provides a new and unique approach for packaging, installing, managing and using training components within IDEs. The three key elements that form embodiments of the present invention are:
(1) The training is componentized, extensible and customizable, embedded in IDEs, such as Eclipse, NetBeans, Visual Studio, etc. Providing a solution to the productivity of IDEs needs to involve the IDE itself. A key ingredient is that the IDE becomes a collection of components, is extensible, and that users can easily configure it.
(2) Learning educational elements are packaged as components and can be consumed, extended, and configured within the IDE.

(3) A management server hosts components and can communicate and interact with the IDE.

Each of these elements are further detailed below with reference to the Figures:

1. Componentized, Extensible and Customizable IDEs

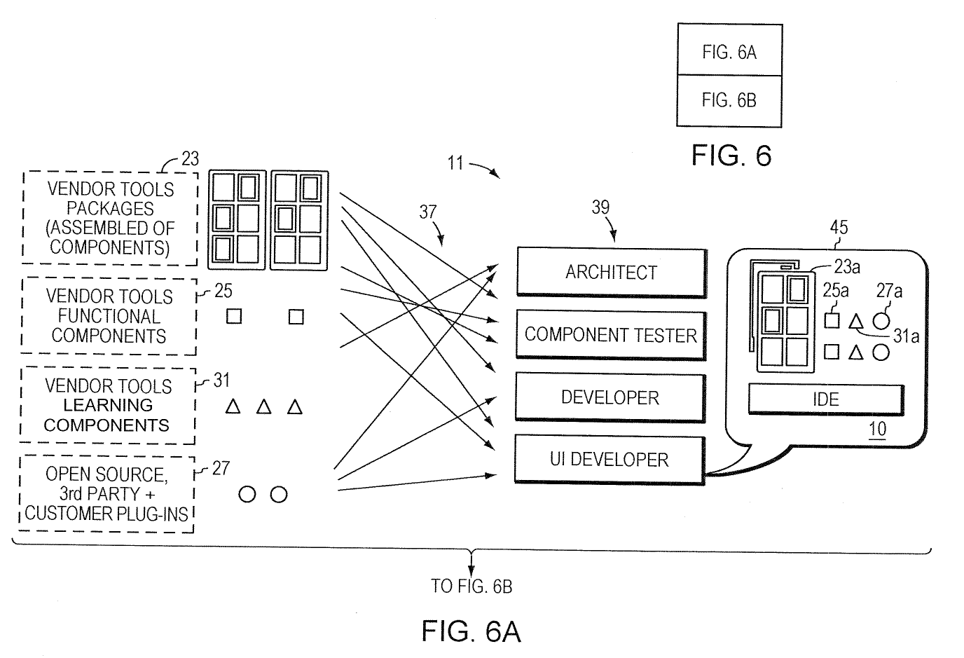

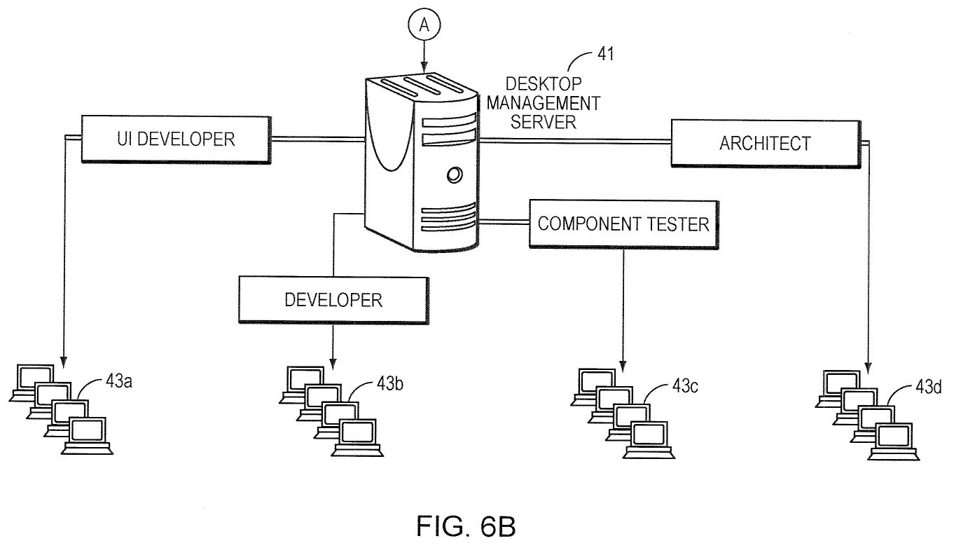

IDEs have evolved to the point where the software vendor that produces the IDE, no longer tries to maintain tight control over the IDE's functionality and appearance. The present invention takes advantage of the componentized approach of IDEs and how they provide functionality to end users. Instead of having one vendor that owns and controls the IDE, the present invention supports or furthers an ecosystem of vendors that provide components for IDEs. This enables the user to pick one or more components 23, 25, 27, 31 (FIG. 6) within his instance of the IDE 10. The number of component combinations grows each day as more components are created.

In embodiments of the present invention, functional components 23, 25, 27 are able to plug in to a host IDE 10. Once plugged-in, the functional component's functionality surfaces in the IDE 10 for use by the end user. If at a later time, the user decides that he no longer wants to use the functional component, he unplugs the functional component and it is no longer available for use within the IDE 10.

The IDE 10 also provides a set of code APIs and configuration files that allow the component author to leverage other plugins and services provided in the IDE 10. This means that when a component is created, it can use other aspects of the IDE 10 to deliver services that the component was meant to provide.

2. Educational Components

A key aspect of this invention is that it requires that educational material no longer needs to be just coarse-grained deliverables that exist outside of the actual work environment. Educational components 31a (FIG. 6) leverage the componentization and extensibility features of the IDE 10 to provide an embedded learning experience for the user 43.

An educational component 31a of the present invention is packaged as a standard component that the IDE 10 can consume. This means that the educational component 31a can be installed into the same host environment as functional components 23, 25, 27. Using a tool and accessing training for that tool, within the same environment, is a unique approach in the art provided by the present invention 11.

The educational component 31a provides a rich and interactive educational experience within the host environment. This includes conceptual or presentational content, such as text, audio, video, and multimedia. It can include interactive quizzes and test facilities to track and measure the student's progress with the material. Known tutorial techniques and test tracking and measuring methods are employed. The present invention educational components 31 also leverage the facilities provided by the IDE 10 so that the student never has to leave the IDE environment to complete the learning tasks. This can include the use of the help system, specialized views, or perspectives and other facilities provided by the IDE. Known hooks, linking/hyperlinking, API (application program interfacing) or other programming integration/interfacing are utilized.

In addition, the user can seamlessly switch between the conceptual or presentational content and exercises that require the use of the functional components 23, 25, 27. The hands-on exercises displayed in the host environment is preferably able to:

a. Call and drive functional aspects of the functional components and host environment

b. Display and work with multimedia including audio, video, and animation

c. Quiz and test a student's performance and send data back to the management server

d. Capture input from the student to customize the exercise, providing links from exercise steps to:

Other content in the host environment, for example, help, tutorials, samples, process guidance, and content within other learning components, and/or

Other content outside the host environment (for example the internet, WAN, and LAN) accessing other content such as help, tutorials, samples, process guidance, and other courses.

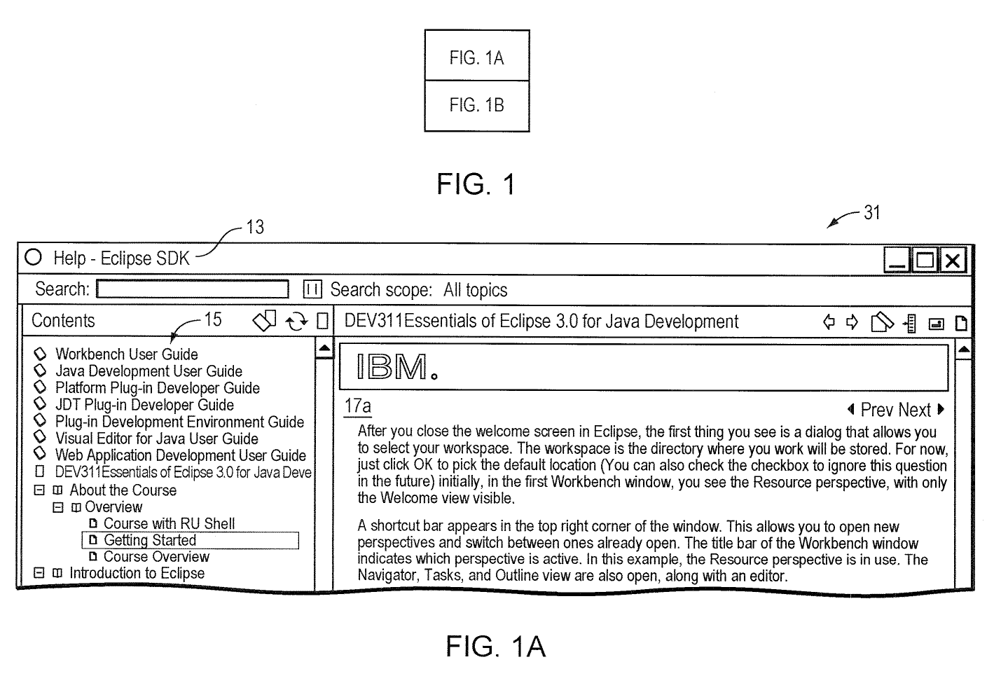

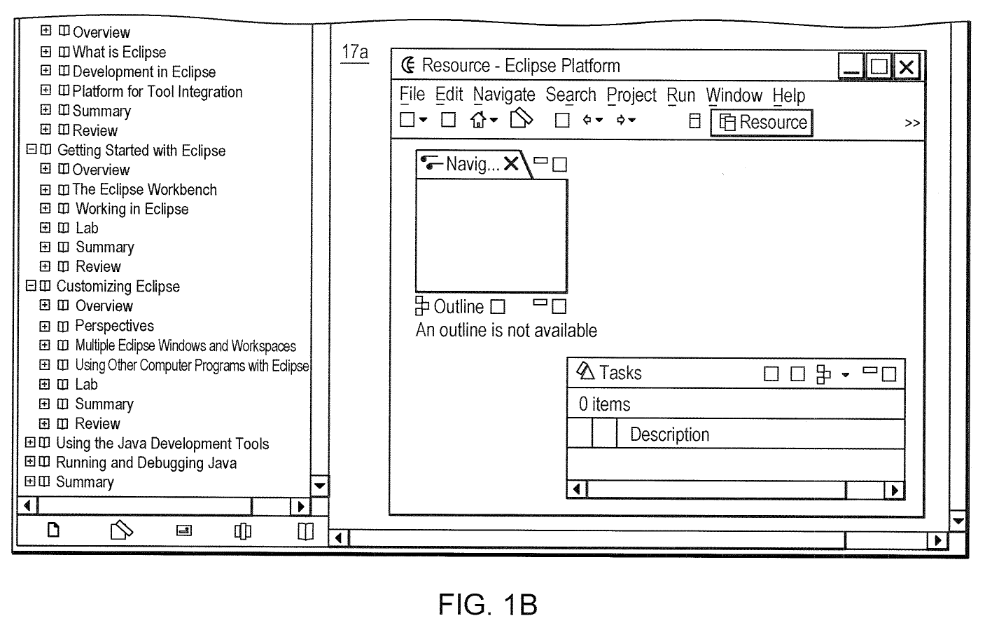

For example, in FIG. 1 the user sees a portion of a learning component 31 within the help system 13. The different sections of the course are presented in an outline or tree fashion in the Contents area 15 on the left hand side of the screen. On the right hand side of the screen, the selected course information 17a is displayed.

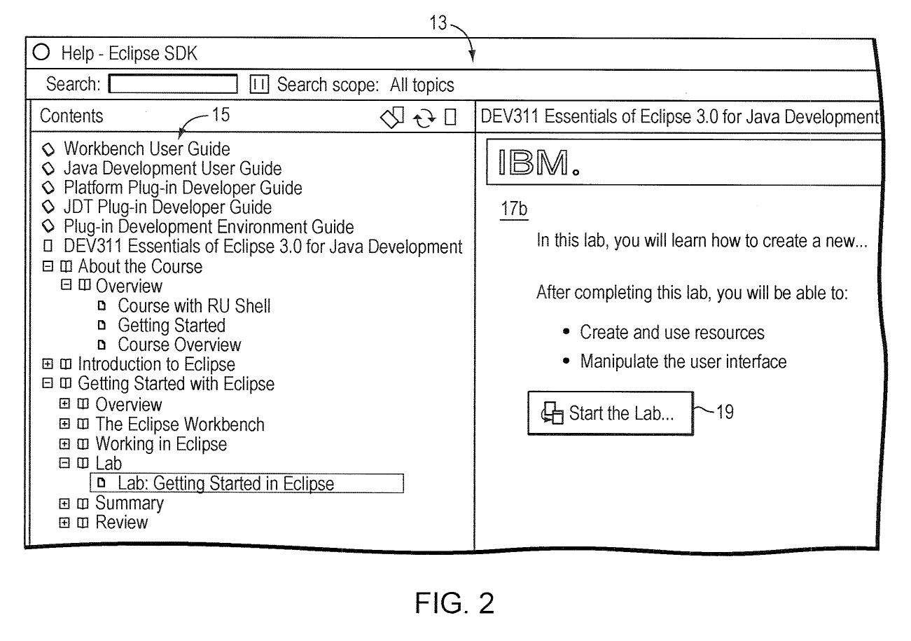

In FIG. 2, the user wants to work on a lab and using the outline of contents 15 on the left hand screen portion, has navigated to a lab exercise. In response to user selection (highlight) of the lab exercise, the help system 13 displays the selected lab exercise 17b on the right-hand side of the screen. The user would typically walk through the different sections of the learning material as outlined in contents area 15 and when he reached the lab overview would read the lab description and click on a hotspot (e.g. button icon or other user interface area) 19 to launch the lab (as shown in FIG. 2). Known technology for implementing contents outline area 15, hotspot 19 and launching of the lab is employed.

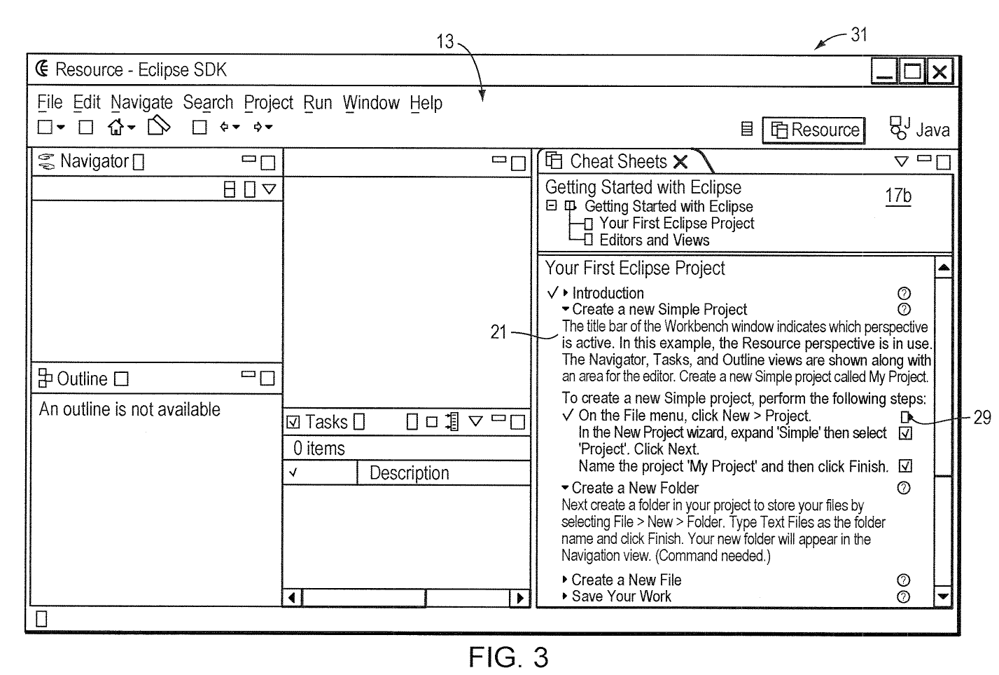

In FIG. 3, the user has already indicated that he wants to work on a lab 17b. Here, the present invention system 11 automatically switches the user to the typical work area within the IDE 10. A portion of the screen displays the instructions 21 needed to walk through the steps of the subject lab 17b. As part of this lab exercise 17b, the learning plugin 31 provides the user with an opportunity to independently walk through the steps of the lab, or the user can click on a hotspot 29 to indicate that he wants the learning component 31 to complete the step automatically. In addition, the educational component 31 may employ multimedia content to show the user how the steps can be done, or what the end results should look like.

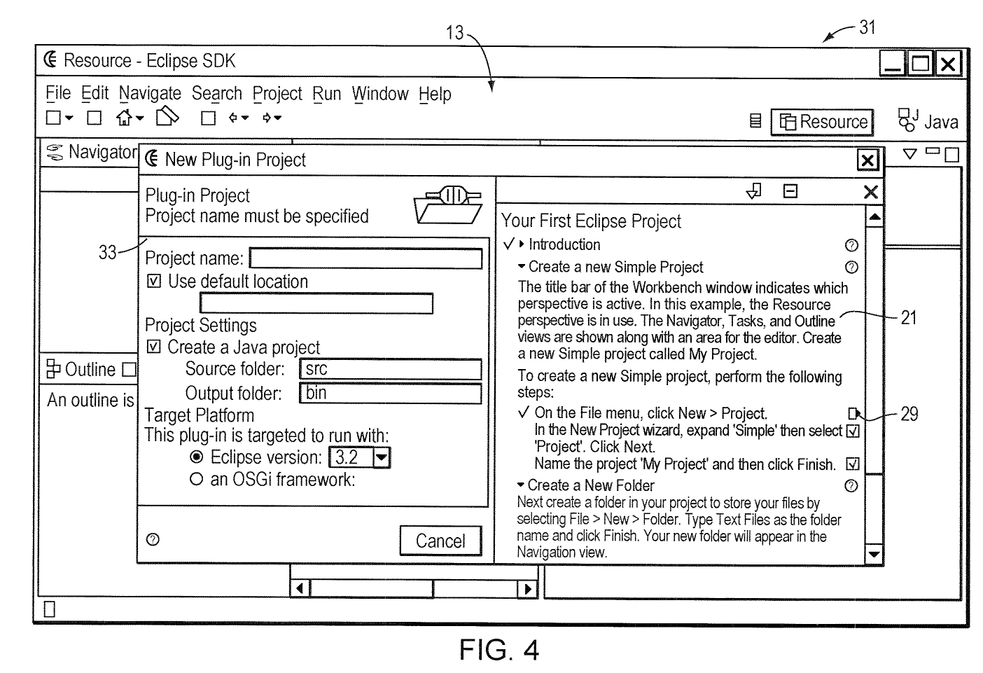

FIG. 4 shows the user how to have the learning component 31 demonstrate a task for them. In this case, the learning component 31 utilizes a wizard 33 from one of the functional components 23, 25, 27 (FIG. 6) of the IDE 10. As shown in the screen capture, as the user walks through the steps of the wizard 33, he is shown the steps for the lab 17b. The lab guidance 21 continues to be available in place (displayed)—as the user works through the task of the wizard 33. Known wizard techniques including coupled display of the lab instructions 21 are used to accomplish this task demonstration of FIG. 4.

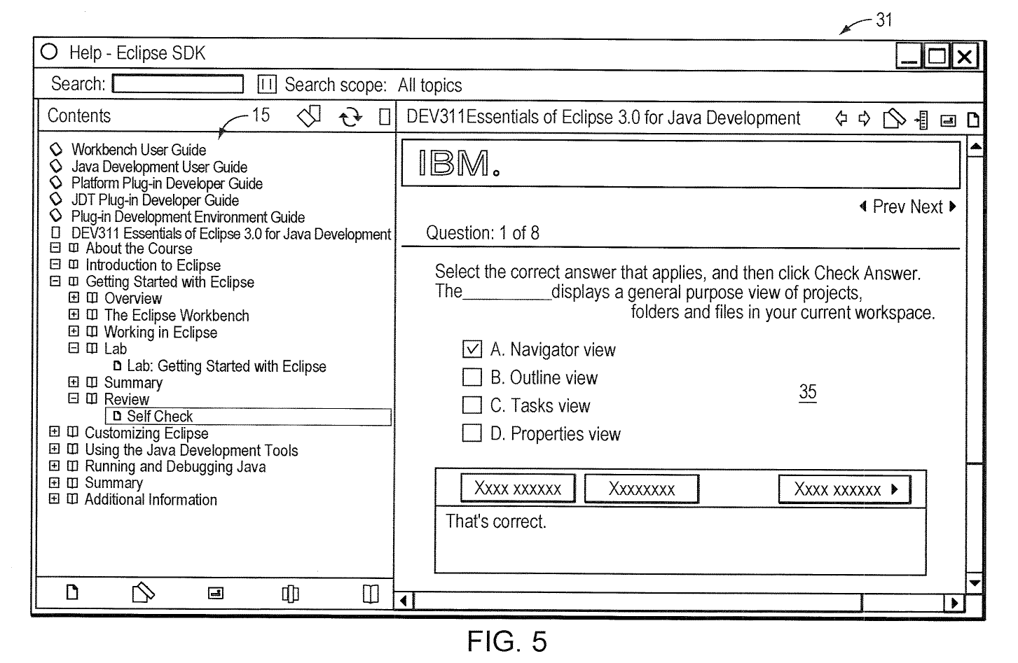

FIG. 5 depicts a scenario where the student has completed both the conceptual presentational material (such as at 33 in FIG. 4 and the like) along with the lab exercises 17b. At this point, the educational component 31 also includes facilities to test and measure the student's comprehension of the material as illustrated at 35 in FIG. 5. As with the other scenarios discussed to this point, this assessment occurs within the work environment. The assessment can take advantage of all aspects of the IDE 10, other installed components, as well as multimedia artifacts. Known testing, evaluation, measuring etc. techniques are employed.

In summary, the present invention 11 provides educational components 31 to the user that he may install and use within his IDE 10. Learning by the user is accomplished within the IDE 10. The user no longer has to switch between the IDE 10 and his web browser or between the IDE 10 and a document. In addition, since the learning component 31a is installed into the user's IDE 10, the user is able to access the training content 31 even when not connected to a network.

This approach is easier for the user, and more cost-effective to deliver and deploy than traditional web-based training especially for large enterprise roll-outs and offers the following advantages:

a. Gains industry mindshare as leaders in information delivery,

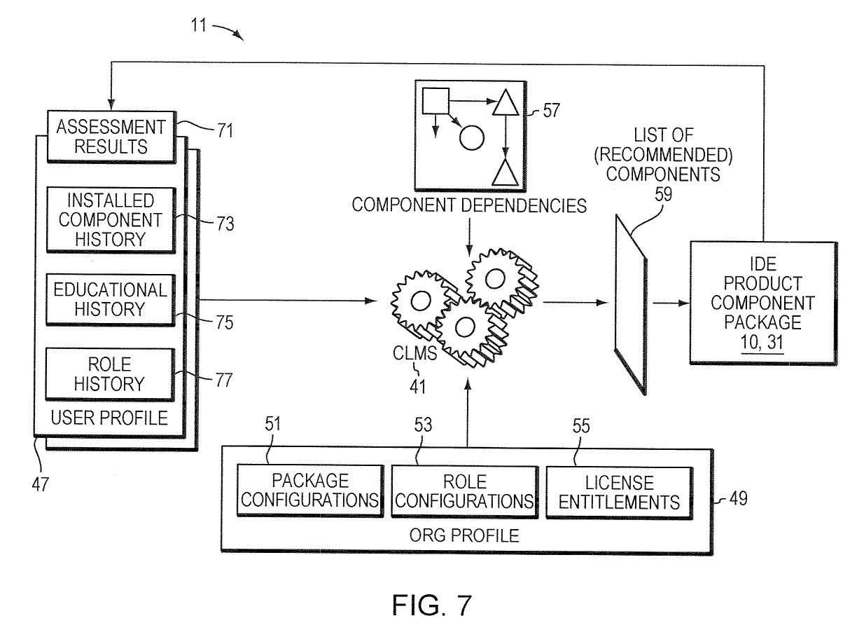

b. Provides an infrastructure to aid in compliance—could be integrated with a Component Learning Management System (CLMS) 41, as discussed further in FIG. 7 and the management section that follows, to record who has taken what course, when, and their final score, and

c. Supports product pull-through for evaluations—the learning material is available during the evaluation period.

3. Management Server

Turning now to FIGS. 6 and 7, integrating the training content/materials 31 with functional components 23, 25, 27 in a manner that forms educational components 31a within a user's instance 45 of an IDE 10 provides the foundation to deploy learning based on the user's role and needs. This integration enhances the ability to have the current version of learning material 31 support on-demand learning. As a result, embodiments of the present invention include a centralized management service 41 for both educational and functional components 23, 25, 27, 31 and corresponding groupings 45 thereof. The centralized management service (server) 41:

a. Generates configurations of specific educational and functional components 23, 25, 27, 45, 31 based on need,

b. Informs the user 43 of the relationship between the educational and functional components 23, 25, 27, 31, 45, and

c. Records and reports on who has taken what course, when, and a student's final score.

Further an organization can host a management service 41 internally or the management service 41 can be hosted externally by a third party. The advantage is:

i. Multiple organizations can access the management service 41 in cases where it makes sense to share this resource, and

ii. A single organization can access its own management service 41 in cases where it makes sense to protect and isolate this resource.

In addition, the management service 41 can recommend related training material 31 based on the courses other peers have installed. In preferred embodiments, the management server 41, collects user and training data and uses the collected data to recommend users 43 for specific projects determined by educational performance and functional component 23, 25, 27 usage.

The foregoing aspects of the present invention management server 41 are illustrated in FIG. 6 as follows. In the invention system 11, the users 43 are of various roles 39, such as user interface developer 43a, other developers 43b, component testers 43c, architect 43d and the like. The management server 41 hosts both vendor functional components 25 and vendor training materials 31 (for educational/learning components 31 of the present invention). Management server 41 also hosts open source components, third party plug-ins, custom plug-ins and the like (illustrated at 27 in FIG. 6), as well as vendor tools packages 23 (i.e. predefined assemblies of functional components 25). That is, vendors can provide a complete set of functional components 25 that are packaged as a product 23. In addition, there can be cases where a vendor releases a new or updated functional components 25 or set of functional components.

The invention system 11 maps the functional components, training materials and other components from 23, 25, 27 and 31 to a set of user roles 39 such as Architect, Developer, etc. The management server 41 maintains this mapping 37 of components and how they relate to user roles 39. In turn, mapping 37 supports management server 41 deployment of learning based on the user's role and needs. In particular, based on the mapping 37, management server 41 associates respective training material 31 with functional and other components 23, 25, 27 and forms learning or educational components 31a. Further, learning components 31a are configured for use within the user's IDE 10. The user's organization or a vendor can host the management server 41. Then each of the users within an organization can connect to the management server 41 to access both the functional components 23, 25, 27 and the training elements 31.

FIG. 7 takes a more in-depth look at the management server 41, also known as a Component Learning Management Server (CLMS). As illustrated on the left-hand side, the CLMS 41 keeps track of profiles 47 for each user 43 who interacts with the invention system 11/management server 41. The user profile 47 is used to keep track of the following information:

a. Assessment Results 71: As a user 43 goes through an educational component 31a, there may be tests and quizzes associated with the training material 31. When the user 43 takes tests and quizzes, the component 31a reports the results back to the CLMS 41 and records them as part of the user's profile 47. The user 43 is able to see their results across all of their completed learning. In addition, the organization can query the results to see how their employees have done with the courses they have taken. This can be used as part of a compliance effort, allowing the organization to ensure that their employees have completed mandatory training (either based on legislation or their own governance policies).

b. Installed Component History 73: The user profile 47 keeps track of currently installed components as well as previously installed components. The individual as well as the organization can query this information. The tracked components include both functional as well as educational components 23, 25, 27, 31, 45.

c. Educational History 75: This section of the user profile 47 keeps track of past educational components 31. It can combine with the assessment results 71 to see what was taken, as well as how well the user did.

d. Role History 77: Over time, a user 43 takes on a number of roles 39 within an organization. CLMS 41 needs to know this information to assist in making training and other component/plug-ins recommendations 59. When making a recommendation, the CLMS 41 reviews the person's current role 39 as well as previous roles 39 using the role history 77.

In addition, each organization that uses the management server 41 has a profile 49 that maintains the following information:

a. Package Configurations 51: A number of components can be deployed together as a package. It is possible that a vendor will sell a group of components as a package. When making recommendations regarding components, it may be that an entire package can be part of that recommendation.

b. Role Configurations 53: In addition to a package of components, it is possible that a set of components can be linked to a role 39. For instance, an organization can specify that components X, Y, and Z be available when there is an “architect” role in an organization.

c. License Entitlements 55: Vendors that supply the components will have license enforcement for the components. As such, the CLMS 41 needs to know what the license status is for a component, as well as the license entitlements that the organization has purchased.

As discussed previously, the CLMS 41 maintains a list 57 of the component dependencies. These dependencies exist between:

a. Functional Component to Functional Component: When a user installs a functional component 23, 25, 27, it may have dependencies with other functional components 23, 25, 27. It's important that the CLMS 41 is aware of these dependencies 57 and takes them into account when making its recommendations 59.

b. Functional Component to Educational Component: When a user 43 installs a functional component, 23, 25, 27 he needs to be made aware of any training material/educational components 31 that they can use to learn how to use the functional component. To do so, the CLMS 41 keeps track of the dependencies 57 between an educational component and a functional component.

c. Educational Component to Educational Component: In addition to dependencies between functional and educational components, the CLMS 41 needs to keep track of dependencies 57 between educational components. For instance, in cases where it is necessary to support multiple skill levels, the CLMS 41 keeps track of the dependencies between these educational components/training materials 31. This could also be used to manage the dependencies between related educational offerings (i.e. the topics are related, but not necessarily just a progression of skill level based on the same topic).

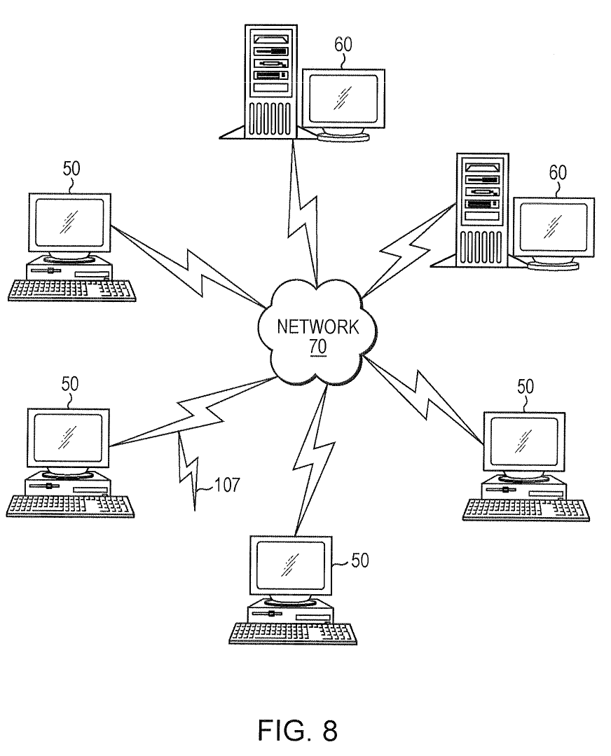

FIG. 8 illustrates a computer network or similar digital processing environment in which the present invention may be implemented.

Client computer(s) 50 and server computer(s) 60 provide processing, storage, and input/output devices executing application programs and the like. Client computer(s) 50 can also be linked through communications network 70 to other computing devices, including other client devices/processes 50 and server computer(s) 60. Communications network 70 can be part of a remote access network, a global network (e.g., the Internet), a worldwide collection of computers, Local area or Wide area networks, and gateways that currently use respective protocols (TCP/IP, Bluetooth, etc.) to communicate with one another. Other electronic device/computer network architectures are suitable.

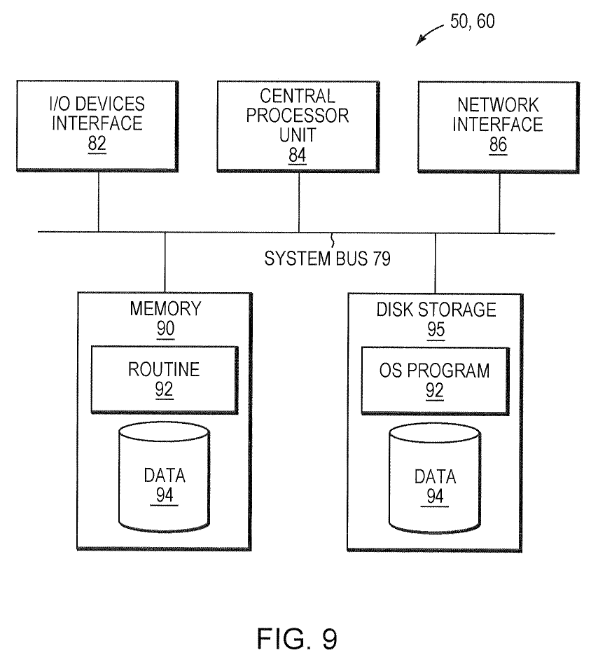

FIG. 9 is a diagram of the internal structure of a computer (e.g., client processor 50 or server computers 60) in the computer system of FIG. 8. Each computer 50, 60 contains system bus 79, where a bus is a set of hardware lines used for data transfer among the components of a computer or processing system. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., keyboard, mouse, displays, printers, speakers, etc.) to the computer 50, 60. Network interface 86 allows the computer to connect to various other devices attached to a network (e.g., network 70 of FIG. 8). Memory 90 provides volatile storage for computer software instructions 92 and data 94 used to implement an embodiment of the present invention (e.g., management server 41, mapping 37, user roles 39, user profiles 47, organization profiles 49, educational components 31 and supporting method/ process detailed above in FIGS. 6 and 7). Disk storage 95 provides non-volatile storage for computer software instructions 92 and data 94 used to implement an embodiment of the present invention. Central processor unit 84 is also attached to system bus 79 and provides for the execution of computer instructions.

In one embodiment, the processor routines 92 and data 94 are a computer program product (generally referenced 92), including a computer readable medium (e.g., a removable storage medium such as one or more DVD-ROM's, CD-ROM's, diskettes, tapes, etc.) that provides at least a portion of the software instructions for the invention system. Computer program product 92 can be installed by any suitable software installation procedure, as is well known in the art. In another embodiment, at least a portion of the software instructions may also be downloaded over a cable, communication and/or wireless connection. In other embodiments, the invention programs are a computer program propagated signal product 107 embodied on a propagated signal on a propagation medium (e.g., a radio wave, an infrared wave, a laser wave, a sound wave, or an electrical wave propagated over a global network such as the Internet, or other network(s)). Such carrier medium or signals provide at least a portion of the software instructions for the present invention routines/program 92.

In alternate embodiments, the propagated signal is an analog carrier wave or digital signal carried on the propagated medium. For example, the propagated signal may be a digitized signal propagated over a global network (e.g., the Internet), a telecommunications network, or other network. In one embodiment, the propagated signal is a signal that is transmitted over the propagation medium over a period of time, such as the instructions for a software application sent in packets over a network over a period of milliseconds, seconds, minutes, or longer. In another embodiment, the computer readable medium of computer program product 92 is a propagation medium that the computer system 50 may receive and read, such as by receiving the propagation medium and identifying a propagated signal embodied in the propagation medium, as described above for computer program propagated signal product.

Generally speaking, the term “carrier medium” or transient carrier encompasses the foregoing transient signals, propagated signals, propagated medium, storage medium and the like.

Accordingly the present invention/system 11 addresses how to achieve higher productivity using an IDE 10 as an educational delivery mechanism and a Component Learning Management System (CLMS) 41 that manages information about the functional component, 23, 25, 27, education components 31, their relationships, and the user's history (roles, projects, and training).

In this disclosure, the learning environment is not intended to continuously change based on the learning capabilities of the learner, but instead the changes are based on the functional components 23, 25, 27 that are installed on the user's system; that is, the educational components 31 are related to the functional components 23, 25, 27. For example, if a user has the Java Development Tools (JDT) installed (the educational component), the related educational components for the JDT are also installed. When the user changes the functional capabilities and installs the C/C++ Development Tools (CDT), the functional components related to the CDT are also installed. Integrating the educational components with functional components provides the foundation to deploy learning based on the user's role and needs. It enhances the ability to have the current version of learning material 31 support on-demand learning. As a result, there is a centralized management service 41 for both educational and functional components 23, 25, 27, 31.

Further, the present invention has a number of educational components that are related to functional components, which in turn a management server 41 hosts. When a component is added to the management server, one is able to specify dependencies 57 between that component and other components of which the management server 41 is already aware. In this way, applicants connect educational components 31 to other educational components and to the functional components 23, 25, 27 that they support. Based on this information, when a user references a functional component (either to install it, or because they have already installed it, or because they have used it in the past), the present invention presents to the user a list of educational components 31 at various levels of depth and expertise that teaches him how to use the component. A key aspect of this invention is that educational material 31 no longer needs to exist as course-grained deliverables residing outside of the actual work environment 10. Now, one can match up the granularity of the training to the capabilities of the functional component and training is automatically tailored to the user's IDE configuration. The user sees only the training content 31a for the IDE components 23a, 25a, 27a installed.

The present invention also has a testing aspect but it is used by the management server 41 to report on who has taken what training. It measures how students perform in their training, what training was taken, and ensures for compliance purposes that the necessary training was completed. Applicants call this the learning process choreography—the ability to work with the management server. This ensures that training relates to the correct functional components, 23a, 25a, 27a, the system 11 recommends which educational components 31 should be taken, and tracks and manages the completed training.

As a further advantage, the present invention looks at how one can better coordinate and deliver training within an IDE 10. A key aspect of the present invention looks at how one or more education components 31 can be made available to an IDE—with recommendations made on which education components are of interest—based on which functional components 23a, 25a, 27a are installed and used (or have been in the past). The extensibility and componentization of the underlying IDE is a key aspect. As more and more functionality is added to the IDE—whereby the functionality leverages the extensibility and componentization of the IDE, applicants find that there is an impedance mismatch between the functional components and available educational offerings.

By embedding the education into the IDE, leveraging extensibility and componentization—the user does not need to leave the IDE to become educated on the functional component of interest. In addition, now that the impedance mismatch between functional components and educational components have been addressed—one can start to create relationships between these components. In the past, a student would have to consult one or more sources and perform an analysis to determine what education they need to obtain. With the present invention, one uses a Component Learning Management System (CLMS) 41 to manage and/or coordinate information about the functional component, education components, the relationships between them, and the history of the user (roles, projects and education completed). Based on this information the CLMS is able to guide the user to a set of education components 31. The education components have a range of topics covered (not just modeling languages) and can vary in depth and level of expertise.

This present invention can be used within all modern IDE's, and can be used to enable a user of the IDE to build any kind of software. The education delivered following the methods and tooling outlined in the disclosure can be in support of any topic that is related to the creation of software—from methodology, requirements, design, construction, debugging, testing, monitoring, support, etc. As such, the present invention could be used to assist a user in building software such as needed to build a system within a vehicle. The intent of the education could be related to one of many possible aspects of this type of development—the requirements for the vehicle, the design of the system, how to test the system, how to perform diagnostics, etc. However, the invention system/methods would not automate how those tasks are accomplished. The expected outcome is that the user of the IDE is enabled to perform the tasks, understand the results of the tasks, and make adjustments as necessary using the tools at hand.

While this invention has been particularly shown and described with references to preferred embodiments thereof, it will be understood by those skilled in the art that various changes in form and details may be made therein without departing from the scope of the invention encompassed by the appended claims.

For example, the present invention may be implemented in a variety of computer architectures. The computer network of FIGS. 8 and 9 are for purposes of illustration and not limitation of the present invention.

The term “training component” is the generic of the learning/educational components or portions thereof and/or training materials or portions thereof.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

What is claimed is:

1. A computer implemented method of training a user to use a computer-based tool, comprising:
providing to an end user a subject computer-based tool, the subject computer-based tool having at least one functional component;
forming an educational component by associating each functional component of the subject computer-based tool with respective training materials; and
integrating the formed educational component into an IDE of the end user in a manner such that end user operation of the educational component and end user operation of the subject computer-based tool is in a same environment.

2. The computer implemented method of claim 1 wherein the associating each functional component with respective training materials is based on the role of the end user.

3. The computer implemented method of claim 2 wherein role of the end user is one of a plurality of roles of the end user; the plurality of roles being any combination of past and present roles of the end-user.

4. The computer implemented method of claim 2 further comprising the step of:
making a recommendation of other training material as a function of end user role, past training and functional component usage by the end user.

5. The computer implemented method of claim 1 wherein the step of forming an educational component further takes into consideration any one or combination of (i) functional component to functional component dependencies, (ii) functional component to educational component dependencies, and (iii) educational component to educational component dependencies.

6. The computer implemented method of claim 1 further comprising the step of centrally managing functional components, training materials and the educational component.

7. The computer implemented method of claim 1 further comprising the step of recording end-user progress including educational components used by the end-user and functional component performance by the end-user.

8. A computer training system for training a user to use a computer-based tool, comprising:
a source of computer-based tools, the source including a subject computer-based tool having at least one functional component; and
an educational component formed by each functional component of the subject computer-based tool being associated with respective training materials in a manner enabling deployment of the educational component to an end user within an IDE of the end user, end user operation of the educational component and end user operation of the subject computer-based tool being in a same environment.

9. The computer training system of claim 8 wherein the association of each functional component with respective training materials is based on the role of the end user.

10. The computer training system of claim 9 wherein role of the end user is one of a plurality of roles of the end user; the plurality of roles being any combination of past and present roles of the end-user.

11. The computer training system of claim 8 further comprising a management server centrally managing and hosting the functional components, training materials and the educational component.

12. The computer training system of claim 11 wherein the management server further makes a recommendation of other training material as a function of end user role, past training and functional component usage by the end user.

13. The computer training system of claim 11 wherein the management server generates the educational component integrated into the IDE of the end user.

14. The computer training system of claim 13 wherein the management server takes into consideration any one or combination of (i) functional component to functional component dependencies, (ii) functional component to educational component dependencies, and (iii) educational component to educational component dependencies.

15. Computer-training apparatus for training a user to use a computer-based tool, comprising:
means for providing to an end-user a subject computer-based tool, the subject computer-based tool having at least one functional component;
generation means for forming an educational component by (a) associating each functional component of the subject computer-based tool with respective training materials and (b) integrating the formed educational component into an IDE of the end user in a manner such that end user operation of the educational component and end user operation of the subject computer-based tool is in a same environment.

16. Computer-training apparatus of claim 15 wherein the associating each functional component with respective training materials is based on the role of the end user.

17. Computer-training apparatus of claim 16 further comprising recommendation means for making a recommendation of other training material as a function of end user role, past training and functional component usage by the end user.

18. Computer-training apparatus of claim 15 further comprising management means for hosting the functional components, training materials and the educational component.

19. Computer-training apparatus of claim 18 where the management means further takes into consideration any one or combination of (i) functional component to functional component dependencies, (ii) functional component to educational component dependencies, and (iii) educational component to educational component dependencies.

20. A computer program product comprising a computer useable medium including a computer readable program, wherein the computer readable program when executed on a computer causes:
providing to an end user a subject computer-based tool, the subject computer-based tool having at least one functional component;
forming an educational component by associating each functional component of the subject computer-based tool with respective training materials; and
integrating the formed educational component into an IDE of the end user in a manner such that end user operation of the educational component and end user operation of the subject computer-based tool is in a same environment.
